(19) United States
(12) Patent Application Publication
(10) Pub. No.: US 2025/0106868 A1
(43) Pub. Date: Mar. 27, 2025

(54) DYNAMIC BEAM INDICATION FOR NETWORK-CONTROLLED FORWARDING IN MOBILE COMMUNICATIONS

(71) Applicant: MEDIATEK INC., Hsinchu City (TW)

(72) Inventors: Cheng-Rung TSAI, Hsinchu City (TW); Lung-Sheng TSAI, Hsinchu City (TW)

(21) Appl. No.: 18/728,609

(22) PCT Filed: Jun. 5, 2023
(86) PCT No.: PCT/CN2023/098291

§ 371 Date: Jul. 12, 2024

Related U.S. Application Data
(60) Provisional application No. 63/357,753, filed on Jul. 1, 2022.
(60) Provisional application No. 63/367,921, filed on Jul. 8, 2022.

(51) Int. Cl. H04W 72/232; H04W 72/044

(52) U.S. Cl. CPC H04W 72/232; H04W 72/046

(57) ABSTRACT

Examples pertaining to dynamic beam indication for network-controlled forwarding in mobile communications are described. An apparatus (e.g., a network-controlled repeater (NCR)) may receive downlink control information (DCI) from a network node. The DCI may include first beam indication information indicating one or more first pairs of a spatial setting and a time-domain resource. The apparatus may also forward a radio signal based on the first beam indication information.

### CROSS REFERENCE TO RELATED PATENT APPLICATION(S)

The present disclosure is part of a non-provisional application claiming the priority benefit of U.S. Patent Application No. 63/357,753, filed 1 Jul. 2022, and U.S. Patent Application No. 63/367,921, filed 8 Jul. 2022. The contents of aforementioned applications are herein incorporated by reference in their entireties.

### TECHNICAL FIELD

The present disclosure is generally related to mobile communications and, more particularly, to dynamic beam indication for network-controlled forwarding in mobile communications.

### BACKGROUND

Unless otherwise indicated herein, approaches described in this section are not prior art to the claims listed below and are not admitted as prior art by inclusion in this section.

To counteract the large path and penetration losses in mobile communications, repeater is introduced in 3^{rd} Generation Partnership Project (3GPP) to extend coverage for 5^{th} Generation (5G) New Radio (NR) networks. In general, a repeater with compatibility of legacy user equipment and lower cost of deployment is used to amplify radio signals and forward the amplified signals from a base station (BS) to a user equipment (UE) (or vice versa). However, the details of introducing repeater in 5G NR networks have not been fully discussed yet and some issues need to be solved. One of the issues relates to dynamic beam indication during the forwarding operations. Therefore, there is a need for a solution of dynamic beam indication for forwarding in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to dynamic beam indication for network-controlled forwarding in mobile communications.

In one aspect, a method may involve a processor of an apparatus (e.g., a network-controlled repeater (NCR)) receiving downlink control information (DCI) from a network node, wherein the DCI comprises first beam indication information indicating one or more first pairs of a spatial setting and a time-domain resource. The method may also involve the processor forwarding a radio signal based on the first beam indication information.

In another aspect, an apparatus may comprise a transceiver which, during operation, wirelessly communicates with a UE and a network node of a wireless network. The apparatus may also comprise a processor communicatively coupled to the transceiver. The processor, during operation, may perform operations comprising receiving, via the transceiver, DCI from the network node, wherein the DCI comprises first beam indication information indicating one or more first pairs of a spatial setting and a time-domain resource; and forwarding, via the transceiver, a radio signal based on the first beam indication information.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of the framework for network-controlled repeater (NCR) under schemes in accordance with implementations of the present disclosure.

FIG. 2 is a diagram depicting an example scenario of applying the conventional design of dynamic beam indication for NCR.

FIG. 3 is a diagram depicting an example scenario of the novel design of dynamic beam indication for NCR under schemes in accordance with implementations of the present disclosure.

FIG. 4 is a diagram depicting an example scenario of a mapping table configured via a medium access control (MAC) control element (CE) for dynamic beam indication for NCR under schemes in accordance with implementations of the present disclosure.

FIG. 5 is a diagram depicting an example scenario of MAC-CE-based dynamic beam indication for NCR under schemes in accordance with implementations of FIG. 4.

FIG. 6 is a diagram depicting an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to RS enhancements in mobile communications. According to the present disclosure, a number of possible solutions may be implemented separately or jointly. That is, although these possible solutions may be described below separately, two or more of these possible solutions may be implemented in one combination or another.

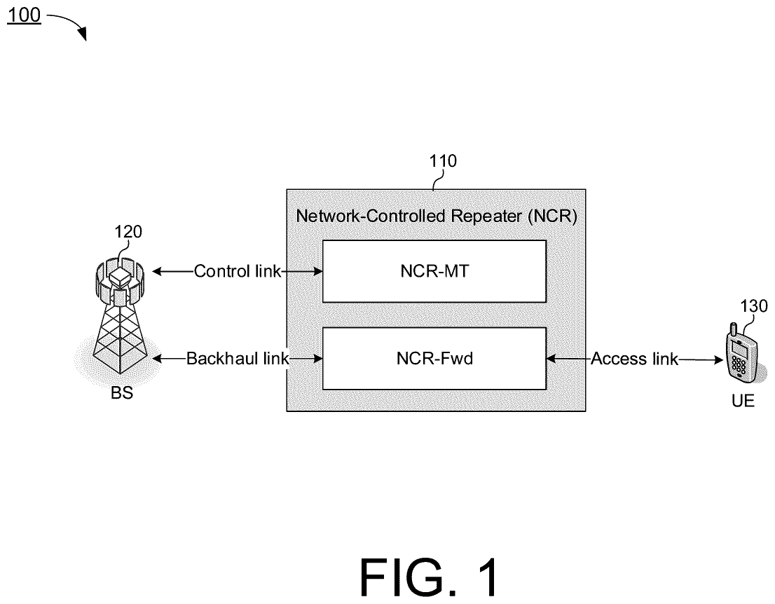

FIG. 1 illustrates an example scenario 100 of the framework for network-controlled repeater (NCR) under schemes in accordance with implementations of the present disclosure. As shown in FIG. 1, an NCR 110 is located between a BS 120 and a UE 130, and is responsible for forwarding radio signals therebetween. The NCR 110 at least includes two function entities, such as the NCR-mobile termination (MT) entity and the NCR-forwarding (Fwd) entity. The NCR-MT entity is responsible for communicating with the BS 120 via a control link (or called C-link) to enable information (e.g., side control information) exchange. The C-link may be based on the NR Uu interface. The NCR-Fwd entity is responsible for performing the amplify-and-forwarding of downlink (DL) or uplink (UL) radio signals between the BS 120 and the UE 130 via the backhaul link (or called B-link) and the access link (or called A-link). The operations of the NCR-Fwd entity may be controlled according to the received side control information from the BS 120.

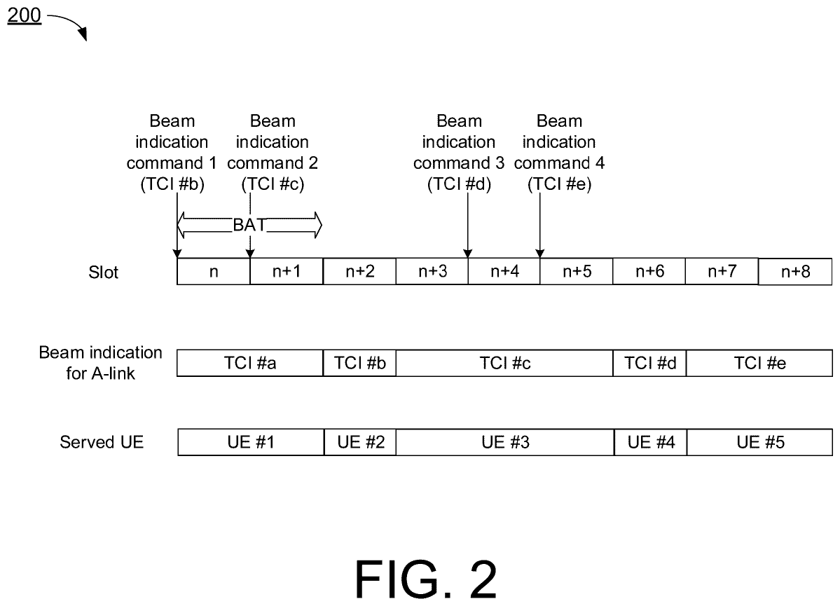

In current 5G NR, beam indication command is provided by a BS (e.g., next generation nodeB (gNB) or transmission reception point (TRP)) to instruct a UE to switch the beam in use for DL/UL communications with the BS. However, for each beam switching, a respective beam indication command needs to be prepared and transmitted. For an NCR serving multiple UEs, beams of these UEs may be different and the NCR may need to perform beam switching over the A-link frequently during the forwarding operations. FIG. 2 illustrates an example scenario 200 of applying the conventional design of dynamic beam indication for NCR. As shown in FIG. 2, beam indication command 1 is transmitted to the NCR at the start of slot n for switching the A-link from a beam associated with transmission configuration indication (TCI) #a to another beam associated with TCI #b, so that the NCR may be able to serve UE 2 in slot n+2. Next, beam indication command 2 is transmitted to the NCR at the start of slot n+1 for switching the A-link from the beam associated with TCI #b to another beam associated with TCI #c, so that the NCR may be able to serve UE 3 in slots n+3 to n+5. Additionally, beam indication command 3 is transmitted to the NCR at the start of slot n+4 for switching the A-link from the beam associated with TCI #c to another beam associated with TCI #d, so that the NCR may be able to serve UE 4 in slot n+6. After that, beam indication command 4 is transmitted to the NCR at the start of slot n+5 for switching the A-link from the beam associated with TCI #d to another beam associated with TCI #e, so that the NCR may be able to serve UE 5 in slots n+7 and n+8. It is noteworthy that the signaling/monitoring overhead for dynamic beam indication will be large if the conventional design for the current 5G NR is applied in the cases of frequent beam switching for the NCR. Accordingly, how to reduce signaling/monitoring overhead is an important issue for dynamic beam indication for NCR. Therefore, a solution is sought to improve the aforementioned issue.

In view of the above, the present disclosure proposes a number of schemes pertaining to dynamic beam indication for NCR. According to the schemes of the present disclosure, one beam indication command (e.g., a medium access control (MAC) control element (CE) and/or a downlink control information (DCI) format) indicating one or more pairs of a spatial setting (e.g., beam index or transmission configuration indication (TCI) state identifier (ID)) and a time-domain resource (e.g., slot(s) or symbol(s)) is supported. The NCR may apply the spatial settings to the corresponding time-domain resources starting from a beam application time (BAT) subsequent to the reception of the beam indication command at the NCR or subsequent to the transmission of an acknowledgement at the NCR. Accordingly, by applying the schemes of the present disclosure, the signaling/monitoring overhead in dynamic beam indication for NCR may be reduced to improve the overall signaling efficiency and radio resource utilization.

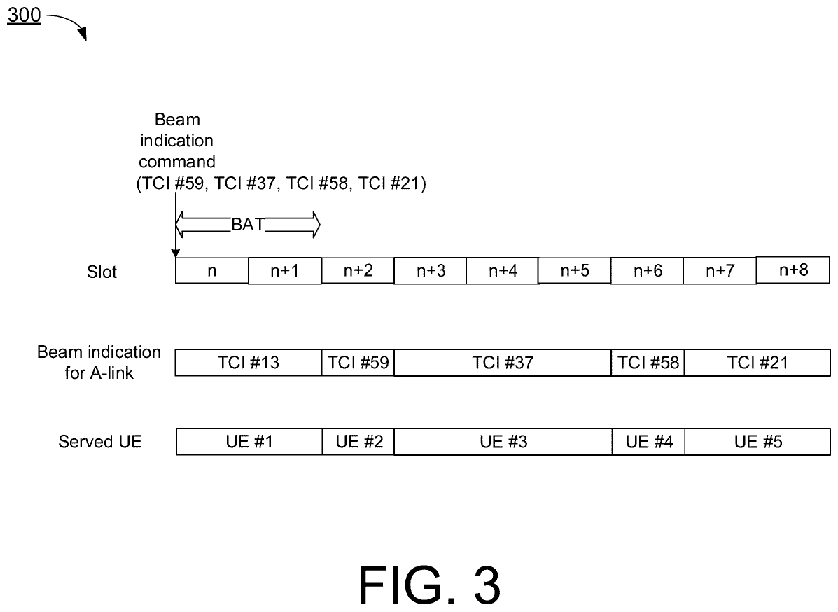

FIG. 3 illustrates an example scenario 300 of the novel design of dynamic beam indication for NCR under schemes in accordance with implementations of the present disclosure. As shown in FIG. 3, one beam indication command is capable of indicating multiple beam indexes or TCI state IDs for a set of slots, where the indicated beam indexes or TCI state IDs are applied to the set of slots starting from a BAT after the UE receives the beam indication command. Alternatively, the indicated beam indexes or TCI state IDs may be applied to the set of slots starting from the BAT after the UE transmits an acknowledgement of receipt of the beam indication command to the NCR. In particular, the beam indication command is transmitted to the NCR at the start of slot n for beam switching over the A-link for slots n+2 to n+8, in the case that the BAT is a preconfigured period of time equal to two slots long. Accordingly, the NCR can be well indicated regarding how to handle the beam switching over the A-link for a set of slots, with just a single beam indication command.

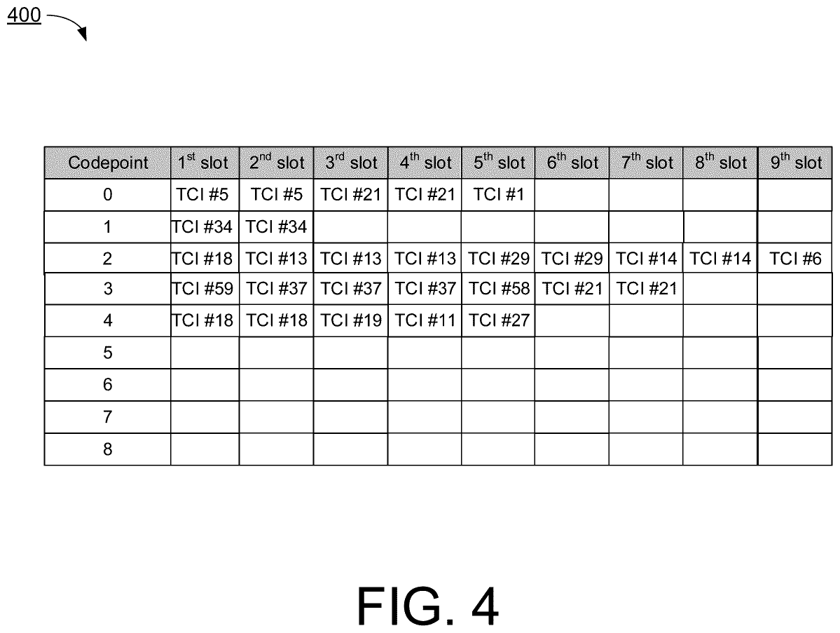

Under a first proposed scheme in accordance with the present disclosure, a MAC-CE-based approach may be applied for dynamic beam indication for NCR. Specifically, a MAC-CE May configure a mapping table which maps a number of beam indexes or TCI state IDs for a number of slots to a number of codepoints of a DCI field. FIG. 4 illustrates an example scenario 400 of the mapping table configured via a MAC CE for dynamic beam indication for NCR under schemes in accordance with implementations of the present disclosure. For each codepoint, each slot in the number of slots is mapped with a beam index or TCI state ID. If only one codepoint is associated with beam index(s) or TCI state ID(s), the associated beam index(s) or TCI state ID(s) is/are applied to the number of slots starting from the BAT after the UE transmits an acknowledgement of receipt of the MAC-CE. If multiple codepoints are associated with beam index(s) or TCI state ID(s), a DCI may be transmitted to indicate one of the codepoints. The beam index(s) or TCI state ID(s) associated with the DCI-indicated codepoint may be applied to the number of slot(s) starting from the BAT after the UE receives the DCI indicating the codepoint, or starting from the BAT after the UE transmits an acknowledgement of receipt of the DCI. The DCI may be associated with a radio network temporary identifier (RNTI) specifically defined for repeater-type device (e.g., NCR).

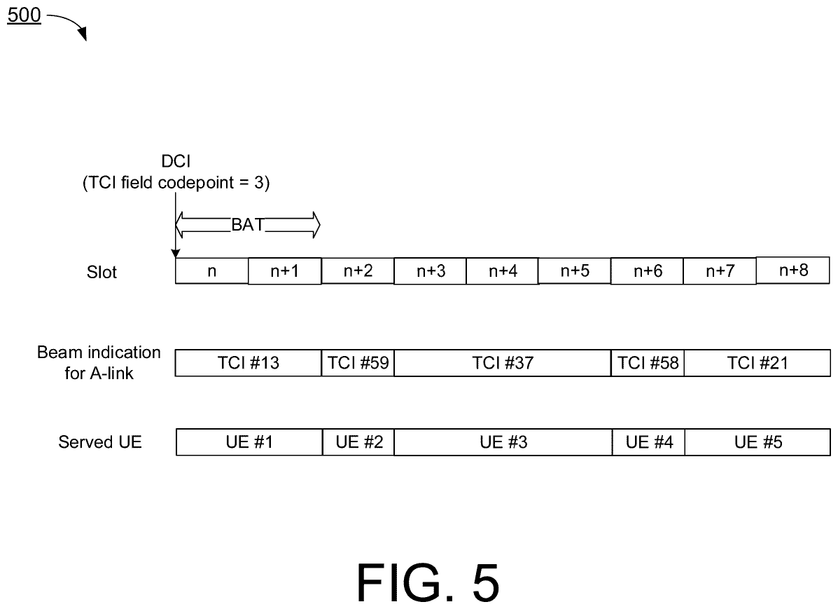

FIG. 5 illustrates an example scenario 500 of the MAC-CE-based dynamic beam indication for NCR under schemes in accordance with implementations of FIG. 4. In scenario 500, a DCI is transmitted to indicate a codepoint, and the beam index(s) or TCI state ID(s) for a number of slots associated with the indicated codepoint may be determined based on the mapping table configured via a MAC CE. As shown in FIG. 5, the codepoint indicated in the DCI is 3, and based on the mapping table, the NCR can determine the following: (1) the TCI state ID for slot n+2 (i.e., the first slot starting from a period of time (e.g., BAT=2 slots) subsequent to the reception of the DCI at the NCR) is TCI #59, (2) the TCI state ID for slot n+3 to slot n+5 (i.e., the second to fourth slots starting from a period of time (e.g., BAT=2 slots) subsequent to the reception of the DCI at the NCR) is TCI #37, (3) the TCI state ID for slot n+6 (i.e., the fifth slot starting from a period of time (e.g., BAT=2 slots) subsequent to the reception of the DCI at the NCR) is TCI #58, and (4) the TCI state ID for slot n+7 and slot n+8 (i.e., the sixth and seventh slots starting from a period of time (e.g., BAT=2 slots) subsequent to the reception of the DCI at the NCR) is TCI #21.

Under a second proposed scheme in accordance with the present disclosure, a DCI-based approach may be applied for dynamic beam indication. Specifically, a DCI associated with an RNTI specifically defined for repeater-type device or a DCI in a specific DCI format for NCR beam indication may indicate one or multiple beam indexes or TCI state IDs for a number of slots. In a first option, the DCI may indicate a beam index or TCI state ID and a number of (contiguous) slots (e.g., represented as: (beam-index, number of slots L)), such that the NCR may apply the transmission (Tx) or reception (Rx) beam indicated by the beam index or TCI state ID for the number of slots. In a second option, the DCI may indicate multiple beam indexes or TCI state IDs for a number of slots (e.g., represented as: [beam-index_0, beam-index_1, . . . , beam-index_N] for (N+1) slots), where N is signaled by network, such that the NCR may apply the Tx/Rx beam according to the indicated information for N+1 slots. In a third option, the DCI may indicate one or multiple pairs of a beam index or TCI state ID and a number of slots (e.g., represented as: [beam-index(n), number of slots L (n)]), such that the NCR may apply the beam-index (1) for L (1) slots, apply the beam-index (2) for L (2) slots after L (1) slots, apply the beam-index (3) for L (3) slots after L (2) slots, and so on.

Under a third proposed scheme in accordance with the present disclosure, if there is/are slot(s) without indication of beam index(s) or TCI state ID(s), the NCR behavior may vary depending on different implementation designs. In one example, the NCR behavior in such case may be up to NCR implementation, i.e., completely determined by the NCR itself. In one example, the NCR may use the last applied/indicated beam index or TCI state ID for the slot(s) without indication of beam index(s) or TCI state ID(s). In one example, the NCR may turn off the A-link for the slot(s) without indication of beam index(s) or TCI state ID(s).

Under a fourth proposed scheme in accordance with the present disclosure, when a same slot/symbol is simultaneously provided with different beam indications by, e.g., a semi-static beam indication (i.e., configured via radio resource control (RRC) signaling) and a dynamic beam indication, the NCR may prioritize the dynamic beam indication over the semi-static beam indication for such slot/symbol.

### Illustrative Implementations

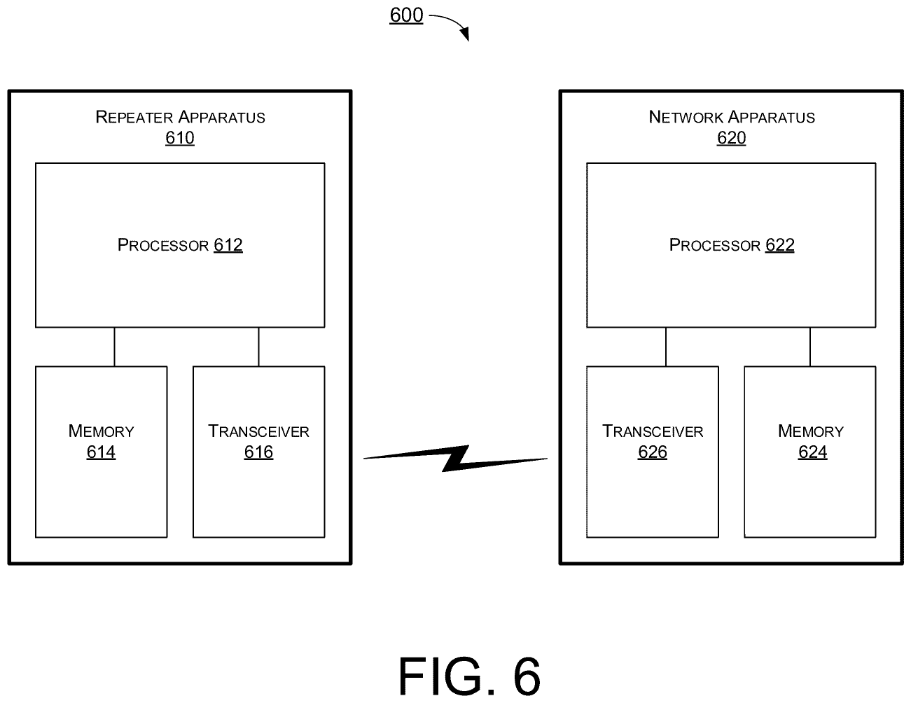

FIG. 6 illustrates an example communication system 600 having an example apparatus 610 and an example apparatus 620 in accordance with an implementation of the present disclosure. Each of apparatus 610 and apparatus 620 may perform various functions to implement schemes, techniques, processes and methods described herein pertaining to dynamic beam indication for network-controlled forwarding in mobile communications, including scenarios/schemes described above as well as process 700 described below.

Apparatus 610 may be a part of an electronic apparatus, a wireless communication apparatus, or a computing apparatus, which may be a repeater-type device, such as an NCR, for amplifying and forwarding radio signals between apparatus 620 and a UE (e.g., a smartphone, a smartwatch, a personal digital assistant, a digital camera, a computing equipment such as a tablet computer, a laptop computer or a notebook computer, or a machine type apparatus such as an a smart thermostat, a smart fridge, a smart door lock, a wireless speaker or a home control center). Alternatively, apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 610 may include at least some of those components shown in FIG. 6 such as a processor 612, for example. Apparatus 610 may further include one or more other components not pertinent to the proposed scheme of the present disclosure (e.g., internal power supply, display device and/or user interface device), and, thus, such component(s) of apparatus 610 are neither shown in FIG. 6 nor described below in the interest of simplicity and brevity.

Apparatus 620 may be a part of an electronic apparatus, which may be a network node, such as a BS, a small cell, a router or a gateway. For instance, apparatus 620 may be implemented in an eNodeB in an LTE, LTE-Advanced or LTE-Advanced Pro network or in a gNB/TRP in a 5G, NR, IoT, NB-IoT or IIoT network. Alternatively, apparatus 620 may be implemented in the form of one or more IC chips such as, for example and without limitation, one or more single-core processors, one or more multi-core processors, or one or more RISC or CISC processors. Apparatus 620 may include at least some of those components shown in FIG. 6 such as a processor 622, for example. Apparatus 620 may further include one or more other components not pertinent to the proposed scheme of the present disclosure (e.g., internal power supply, display device and/or user interface device), and, thus, such component(s) of apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to dynamic beam indication for network-controlled forwarding in mobile communications in accordance with various implementations of the present disclosure.

In some implementations, apparatus 610 may also include a transceiver 616 coupled to processor 612 and capable of wirelessly transmitting and receiving data. In some implementations, transceiver 616 may be capable of wirelessly communicating with different types of UEs or wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs or repeaters of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of capabilities of apparatus 610, as an NCR, and apparatus 620, as a network node (e.g., BS), is provided below.

Under certain proposed schemes in accordance with the present disclosure with respect to dynamic beam indication for network-controlled forwarding in mobile communications, processor 612 of apparatus 610, implemented in or as an NCR, may receive, via transceiver 616, downlink control information (DCI) from apparatus 620, implemented in or as a network node. Specifically, the DCI may include first beam indication information indicating one or more first pairs of a spatial setting and a time-domain resource. Additionally, processor 612 may forward, via transceiver 616, a radio signal based on the first beam indication information.

In some implementations, the spatial setting may include a beam index or a TCI state ID.

In some implementations, the time-domain resource may include one or more slots or one or more symbols in a slot.

In some implementations, the DCI may be associated with an RNTI for an NCR.

In some implementations, the DCI may be associated with a DCI format specific for NCR beam indication.

In some implementations, processor 612 may also receive, via transceiver 616, an RRC configuration from apparatus 620. Specifically, the RRC configuration may include second beam indication information indicating one or more second pairs of a spatial setting and a time-domain resource. Additionally, processor 612 may also apply the first beam indication information over the second beam indication information in a set of symbols during forwarding the radio signal, in a case that the time-domain resource in the first pairs overlaps with the time-domain resource in the second pairs in the set of symbols.

In some implementations, forwarding the radio signal may be performed after a period of time (e.g., a BAT) subsequent to a reception of the DCI at apparatus 610.

In some implementations, forwarding the radio signal may be performed after a period of time (e.g., a BAT) subsequent to a transmission of an acknowledgement of the DCI at apparatus 610.

In some implementations, forwarding the radio signal may further include: receiving the radio signal via an access link; or transmitting the radio signal via the access link.

### Illustrative Processes

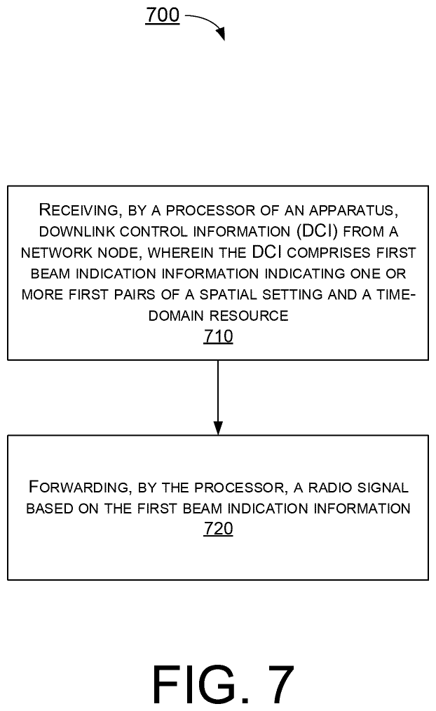

FIG. 7 illustrates an example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to dynamic beam indication for network-controlled forwarding in mobile communications. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 610 as well as any variations thereof. Solely for illustrative purposes and without limiting the scope, process 700 is described below in the context of apparatus 610 as an NCR. Process 700 may begin at block 710.

At 710, process 700 may involve processor 612 of apparatus 610, implemented in or as an NCR, receiving, via transceiver 616, DCI from a network node, wherein the DCI comprises first beam indication information indicating one or more first pairs of a spatial setting and a time-domain resource. Process 700 may proceed from 710 to 720.

At 720, process 700 may involve processor 612 forwarding, via transceiver 616, a radio signal based on the first beam indication information.

In some implementations, the spatial setting may include a beam index or a TCI state ID.

In some implementations, the time-domain resource may include one or more slots or one or more symbols in a slot.

In some implementations, the DCI may be associated with an RNTI for an NCR.

In some implementations, the DCI may be associated with a DCI format specific for NCR beam indication.

In some implementations, process 700 may further involve processor 612 receiving, via transceiver 616, an RRC configuration from the network node. Specifically, the RRC configuration may include second beam indication information indicating one or more second pairs of a spatial setting and a time-domain resource. Additionally, process 700 may involve processor 612 applying the first beam indication information over the second beam indication information in a set of symbols during forwarding the radio signal, in a case that the time-domain resource in the first pairs overlaps with the time-domain resource in the second pairs in the set of symbols.

In some implementations, forwarding the radio signal may be performed after a period of time subsequent to a reception of the DCI at apparatus 610.

In some implementations, forwarding the radio signal may be performed after a period of time subsequent to a transmission of an acknowledgement of the DCI at apparatus 610.

In some implementations, forwarding the radio signal may include: receiving the radio signal via an access link; or transmitting the radio signal via the access link.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” c.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, downlink control information (DCI) from a network node, wherein the DCI comprises first beam indication information indicating one or more first pairs of a spatial setting and a time-domain resource; and
forwarding, by the processor, a radio signal based on the first beam indication information.

2. The method of claim 1, wherein the spatial setting comprises a beam index or a transmission configuration indication (TCI) state identifier (ID).

3. The method of claim 1, wherein the time-domain resource comprises one or more slots or one or more symbols in a slot.

4. The method of claim 1, wherein the DCI is associated with a radio network temporary identifier (RNTI) for a network-controlled repeater (NCR).

5. The method of claim 1, wherein the DCI is associated with a DCI format specific for NCR beam indication.

6. The method of claim 1, further comprising:
receiving, by the processor, a radio resource control (RRC) configuration from the network node, wherein the RRC configuration comprises second beam indication information indicating one or more second pairs of a spatial setting and a time-domain resource; and
applying, by the processor, the first beam indication information in a set of symbols during forwarding the radio signal, in a case that the time-domain resource in the first pairs overlaps with the time-domain resource in the second pairs in the set of symbols.

7. The method of claim 1, wherein forwarding the radio signal is performed after a period of time subsequent to a reception of the DCI at the apparatus.

8. The method of claim 1, wherein forwarding the radio signal is performed after a period of time subsequent to a transmission of an acknowledgement of the DCI at the apparatus.

9. The method of claim 1, wherein forwarding the radio signal comprises:
receiving the radio signal via an access link; or
transmitting the radio signal via the access link.

10. The method of claim 1, wherein the apparatus is a network-controlled repeater (NCR).

11. An apparatus, comprising:
a transceiver which, during operation, wirelessly communicates with a user equipment (UE) and a network node of a wireless network; and
a processor communicatively coupled to the transceiver such that, during operation, the processor performs operations comprising:
receiving, via the transceiver, downlink control information (DCI) from the network node, wherein the DCI comprises first beam indication information indicating one or more first pairs of a spatial setting and a time-domain resource; and
forwarding, via the transceiver, a radio signal based on the first beam indication information.

12. The apparatus of claim 11, wherein the spatial setting comprises a beam index or a transmission configuration indication (TCI) state identifier (ID).

13. The apparatus of claim 11, wherein the time-domain resource comprises one or more slots or one or more symbols in a slot.

14. The apparatus of claim 11, wherein the DCI is associated with a radio network temporary identifier (RNTI) for a network-controlled repeater (NCR).

15. The apparatus of claim 11, wherein the DCI is associated with a DCI format specific for NCR beam indication.

16. The apparatus of claim 11, wherein, during operation, the processor further performs operations comprising:
receiving, via the transceiver, a radio resource control (RRC) configuration from the network node, wherein the RRC configuration comprises second beam indication information indicating one or more second pairs of a spatial setting and a time-domain resource; and
applying the first beam indication information over the second beam indication information in a set of symbols during forwarding the radio signal, in a case that the time-domain resource in the first pairs overlaps with the time-domain resource in the second pairs in the set of symbols.

17. The apparatus of claim 11, wherein forwarding the radio signal is performed after a period of time subsequent to a reception of the DCI at the apparatus.

18. The apparatus of claim 11, wherein forwarding the radio signal is performed after a period of time subsequent to a transmission of an acknowledgement of the DCI at the apparatus.

19. The apparatus of claim 11, wherein forwarding the radio signal comprises:
receiving the radio signal via an access link; or
transmitting the radio signal via the access link.

20. The apparatus of claim 11, wherein the apparatus is a network-controlled repeater (NCR).
